(19) United States
(12) Patent Application Publication
(10) Pub. No.: US 2024/0405968 A1
(43) Pub. Date: Dec. 5, 2024

(54) EXECUTING COMPLEX COMPUTATIONS USING SPLIT GRAPHS

(71) Applicant: International Business Machines Corporation, Armonk, NY (US)

(72) Inventors: Nir DRUCKER, Zichron Yaakov (IL); Ehud AHARONI, Kfar Saba (IL); Hayim SHAUL, Kfar Saba (IL)

(21) Appl. No.: 18/329,001

(22) Filed: Jun. 5, 2023

(51) Int. Cl. H04L 9/00

(52) U.S. Cl. CPC H04L 9/008

(57) ABSTRACT

An example system includes a processor to split a graph of operations on tensors into even and odd vertical layers. In response to detecting even-even or odd-odd connections, the processor can fill the even-even or odd-odd connections using a reshape operation. The processor can also initialize outputs on a same layer type with a random packing data structure shape from a first group. The processor can then execute a breadth-first search backward based on a minimum number of shapes per layer.

### BACKGROUND

The present techniques relate to homomorphic encryption. More specifically, the techniques relate to efficiently performing complex computations under homomorphic encryption.

### SUMMARY

According to an embodiment described herein, a system can include processor to split a graph of operations on tensors into even and odd vertical layers. The processor can also further, in response to detecting even-even or odd-odd connections, fill the even-even or odd-odd connections using a reshape operation. The processor can also initialize outputs on a same layer type with a random packing data structure shape from a group of compatible shapes. The processor can then execute a breadth-first search backward based on a minimum number of shapes per layer.

According to another embodiment described herein, a method can include splitting, via a processor, a graph of operations on tensors into even and odd vertical layers. The method can further include, in response to detecting even-even or odd-odd connections, filling, via the processor, the even-even or odd-odd connections using a reshape operation. The method can also further include initializing, via the processor, outputs on a same layer type with a random packing data structure shape from a group of compatible shapes. The method can also include executing, via the processor, a breadth-first search backward based on a minimum number of shapes per layer.

According to another embodiment described herein, a computer program product for executing complex computations can include computer-readable storage medium having program code embodied therewith. The program code executable by a processor to cause the processor to split a graph of operations on tensors into even and odd vertical layers. The program code can also cause the processor to, in response to detecting even-even or odd-odd connections, fill the even-even or odd-odd connections using a reshape operation. The program code can also cause the processor to initialize outputs on a same layer type with a random packing data structure shape from a group of compatible shapes. The program code can also cause the processor to execute a breadth-first search backward based on a minimum number of shapes per layer.

### BRIEF DESCRIPTION OF THE SEVERAL VIEWS OF THE DRAWINGS

FIG. 1 is a block diagram of an example computing environment that contains an example of an environment for the execution of at least some of the computer code involved in performing the inventive methods, such as a tile tensor graph matrix multiplication planner module;

FIG. 2 is an example tangible, non-transitory computer-readable medium that can perform complex computations using fast tile tensor matrix multiplication;

FIG. 3 is a process flow diagram of an example method that can execute a tile tensor graph matrix multiplication;

FIG. 4 is a process flow diagram of an example method that can minimize a cost of a complex computation using fast tile tensor matrix multiplication;

FIG. 5A is an example graph split into even and odd vertical layers with an even-even connection;

FIG. 5B is an example graph split into even and odd vertical layers with a representation of a multiplication by an identity matrix used to replace the even-even connection;

FIG. 5C is an example graph with re-ordered shapes assigned to the odd layer; and

FIG. 6 is a block diagram of an example system for performing complex computations using fast tile tensor matrix multiplication.

### DETAILED DESCRIPTION

Homomorphic Encryption (HE) schemes may be used to encrypt data while enabling operations to be performed on the encrypted data. In particular, a HE scheme is a cryptosystem that allows its users to evaluate any circuit or function on encrypted data using the following four methods: Gen, Enc, Dec, Eval. For example, a client device can use the Gen method to generate a pair of secret and public keys sk, pk. The client device can store the secret key and publish the public key. Using public key pk, an untrusted party can encrypt sensitive data m; by calling cᵢ=Encₚₖ(mᵢ). Subsequently, the client device can prompt an untrusted entity to execute the function cᵣₑₛ=Evalₚₖ(f,(c₁, . . . , cₙ)) in order to evaluate a function f on some ciphertexts cᵢ and store the results in another ciphertext cᵣₑₛ. To decrypt cᵣₑₛ using sk, the client calls mᵣₑₛ=Decₛₖ(cᵣₑₛ). An HE scheme is correct when m=Dec(Enc(m)) and is approximately correct when m=Dec(Enc(m))+epsilon, for some relatively small epsilon that depends on scheme parameters.

HE packing is used to perform HE operations more efficiently. For example, some HE schemes, such as CKKS, operate on ciphertexts in a homomorphic single instruction multiple data (SIMD) fashion. This means that a single ciphertext encrypts a fixed-size vector, and the homomorphic operations on the ciphertext are performed slot-wise on the elements of the plaintext vector. To utilize the SIMD feature, more than one input element is packed and encrypted in every ciphertext. The packing method can dramatically improve the latency (i.e., time to perform computation), throughput (i.e., number of computations performed in a unit of time), communication costs, and memory requirements.

A tile tensor is a data structure that makes packing easier. Tile tensors are data structures that pack tensors in fixed-size chunks, called tiles. In various examples, tensors may be multidimensional arrays. For example, tensors may be vectors or matrices. Having a fixed size, this tile tensor data structure fits naturally with HE because each tile can be encrypted into a single ciphertext, where the different elements of each tile are mapped into different slots of the ciphertext. In addition, tensors may also be used to implement various layers of neural network such as convolutional or fully-connected layers. Moreover, the same tensor can be covered by tiles of different shapes of the same size. For example, a matrix can be naively covered by column-vectors or by row-vectors, but the matrix can also be covered by two-dimensional tiles, as long as the number of elements in the tile matches the number of slots in the ciphertext. Furthermore, tile tensors allow other manipulations such as duplicating elements along one or more dimensions. Some frameworks allow to easily switch between one tile shape to another and also easily set the amount of duplication along each dimension. For example, packing a matrix m1 using tile tensors can be performed using two-dimensional (2D) or three-dimensional (3D) tile tensors, depending on the context. As one example, when the goal is to multiply a matrix m1 by a vector v. 2D objects may be used for m1 and v. As another example, if the goal is to multiply matrix m1 by another matrix m2, then 3D objects may be used. Vector v, matrix m1, and matrix m2 may thus be packed using different representations, also referred to herein as shapes, that depend on the context. For example, vector v may be packed in either the first dimension of the tile tensor and duplicated over its second dimension, or vice versa. In some instances, matrix m1, and matrix m2 may be packed over two of the three dimensions of a 3D tile tensor, and the third dimension then used for broadcasting the matrix. A matrix can be packed as-is or in a transposed way. In general, there are thus six different ways to pack a matrix.

In order to perform a vector-matrix or matrix-matrix multiplication, the tile-tensor dimensions need to agree. This is similar to standard vector-matrix or matrix-matrix multiplication, where some cases may require transposing at least one of the objects. However, unlike the standard vector-matrix or matrix-matrix multiplication, performing a transpose or a reshape operation on tile tensors under HE may not be straightforward. For example, this operation may often require moving every element to a different position, which in practice may involve n² rotations and masking operations for an n-element matrix.

As one specific example, the packed and encrypted tile tensors include four matrices m1[4,5], m2[5,6], m3[6,7], and m4[7,8] that are to be multiplied together, where matrix m1 has four rows and five columns, matrix m2 has five rows and six columns, etc. As used herein, lower-case letters represent matrices and upper-case letters represent 3D tile tensors that pack the matrices. To have all the dimensions agree, matrices m1-m4 may be packed as follows in tiles of 16,384 slots:
M1 shape=[ 5/16, 4/16, */64]
M2 shape=[ 5/16, */16, 6/64]
M3 shape=[ 7/16, */16, 6/64]
M4 shape=[ 7/16, */16, 8/64]
   where * indicates a duplicated value. For example, in M1, the matrix m1 that is packed in the first and second dimensions, is duplicated 64 times over the third dimension. For example, the matrix may be duplicated using a method known as broadcasting. In M2, the m2 matrix that is packed in the first and third dimensions is duplicated 16 times over the second dimension. The reason for such packing is demonstrated in the complete multiplication sequence:
M1*M2 shape=[*/16, 4/16, 6/64]
—M3 shape=[ 7/16, */16, 6/64]
M1*M2*M3 shape=[ 7/16, 4/16, 1?/64]
M1*M2*M3 shape (After clearing unknowns)=[ 7/16, 4/16, 1/64]
M1*M2*M3 shape (After duplicating)=[ 7/16, 4/16, */64]
—M4 shape=[ 7/16, */16, 8/64]
M1*M2*M3*M4 shape=[*/16, 4/16, 8/64]

In particular, for every multiplication, two operands agree on one dimension and are broadcast on different dimensions. Thus, if the tile tensor M3 instead had the shape M3 shape=[*/16, 7/16, 6/64], then the multiplier may not able to use it as its shape does not agree with the shape of M1*M2.

When performing a chain of operations or even a tree, it may be easy to back-propagate over the matrix multiplications to find the exact shapes needed. In fact, this back-propagation can be executed whenever the graph of multiplications does not involve an undirected cycle. However, consider the following example: given matrices m1, m2, m3 be as before, the expression m1*m2+m2*m3 may sought to be calculated. A simple assignment of packing shapes would be to assign each product m1*m2 and m2*m3 the same pair of shapes in the same order. This will guarantee their results can be added together. Thus, the left hand side of each matrix m1,m2 will be packed with the first dimension duplicated, and the right hand side of each matrix m2,m3 with the second dimension duplicated. This generates a conflict for m2. Therefore, a second packing or a costly reshape may be performed. Trying to reuse m2's same packing for the second product as well results in a conflict when attempting to add the two products together. Generally, for complicated graphs, such conflicts may be difficult to solve. In particular, starting from the end of a complicated graph, and going backwards and assigning shapes that will be compatible with each other may end up with many conflicts. Thus, each input may have to be packed many times, or many costly reshapes may take place.

According to embodiments of the present disclosure, a method for fast tile tensor matrix multiplication chains includes splitting a graph of operations on tensors into even and odd vertical layers. If there are even-even or odd-odd connections, the method includes filling the even-even or odd-odd connections up using a reshape operation. For example, the reshape operation may be a multiplication. The method includes initialing all outputs on the same layer type with a random packing data structure shape from a group of shapes. The method includes executing a BFS backward, considering the minimum number of shapes needed per layer. The method includes stopping once reaching the input or a point where all nodes of a layer are assigned with three shapes. Thus, embodiments of the present disclosure enable efficient computation of complex matrix multiplication graphs using low runtime and memory. In particular, the embodiments enable the efficient computation of multiplication graphs as in the example above. In addition, the embodiments enable the efficient computation of addition chain exponentiation under homomorphic encryption. For example, the embodiments provide an efficient way to compute the power b of a square matrix M (Mb). For example, an addition chain exponentiation to compute the matrix M⁶ is M⁶=M²*M⁴=M²*(M²*M²), where every M² should have a different shape in order to enable execution of the matrix multiplication. The embodiments herein save half of the multiplication cost because only three instead of six total potential multiplications are used in this example.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such tile tensor graph matrix multiplication planner module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

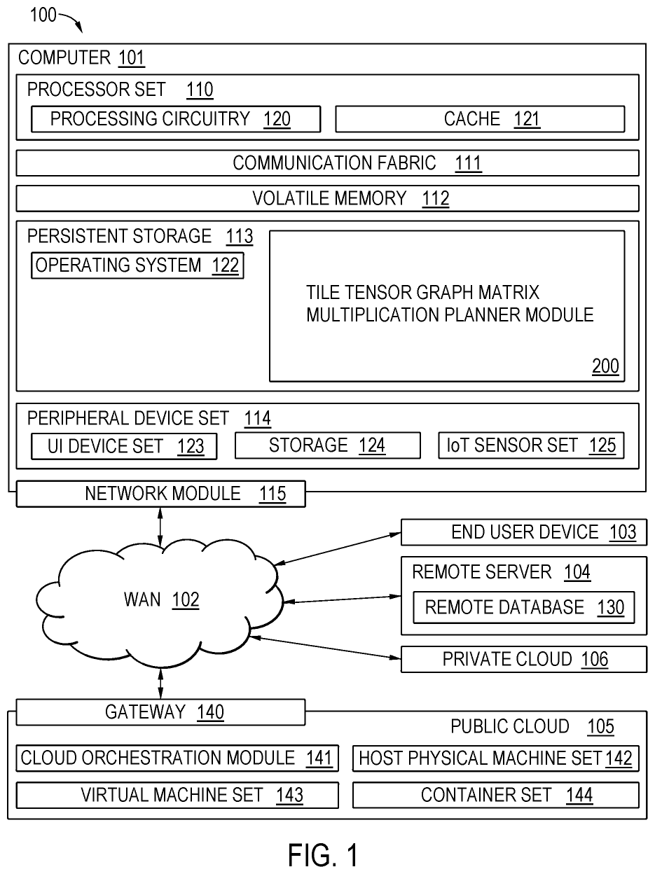

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

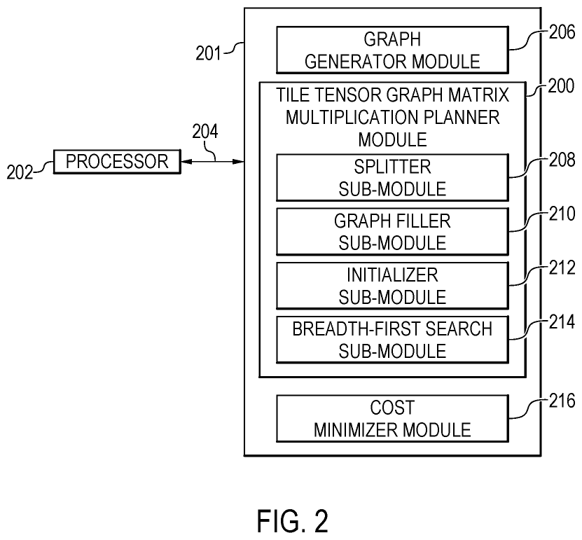

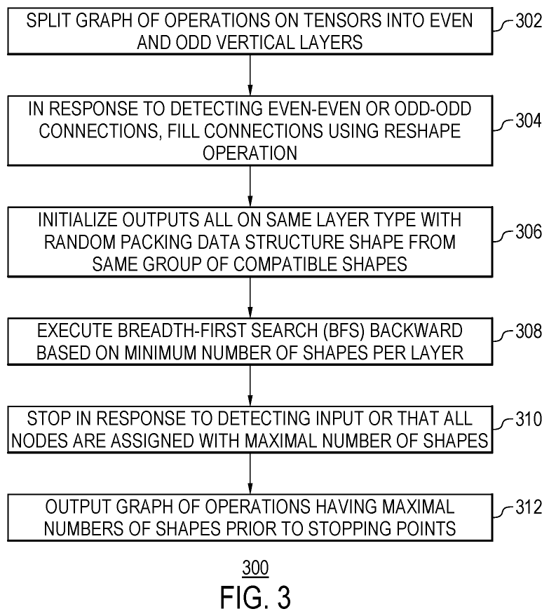

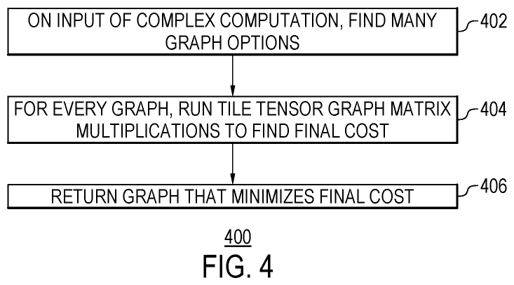

Referring now to FIG. 2, a block diagram is depicted of an example tangible, non-transitory computer-readable medium 201 that can perform complex computations using fast tile tensor matrix multiplication. The tangible, non-transitory, computer-readable medium 201 may be accessed by a processor 202 over a computer interconnect 204. Furthermore, the tangible, non-transitory, computer-readable medium 201 may include code to direct the processor 202 to perform the operations of the methods 300 and 400 of FIGS. 3 and 4.

The various software components discussed herein may be stored on the tangible, non-transitory, computer-readable medium 201, as indicated in FIG. 2. For example, a graph generator module 206 includes code to generate a number of graphs of operations based on a received input complex computation. For example, the problem of solving addition chains (even without HE), is known to be hard and different solutions may exist. In the context of homomorphic encryption, each one of the different solutions can be an input graph to the system. In various examples, the “optimal” addition chain solution in cleartext may not eventually turn out to be the optimal also under HE. Rather, a sub-optimal chain solution in cleartext may turn out to be the optimal under the embodiments described herein. The tile tensor graph matrix multiplication planner module 200 includes a splitter sub-module 208 that includes code to split a graph of operations on tensors into even and odd vertical layers. The splitter sub-module 208 further includes code to split a number of potential shapes for a data structure into any number of groups. For example, in the case of three-dimensional tile tensors, the splitter sub-module 208 further includes code to split the six possible matrix shapes into two groups including the first group, wherein the even vertical layers include shapes from one of the two groups and the odd vertical layers include shapes from the other of the two groups. The tile tensor graph matrix multiplication planner module 200 includes a graph filler sub-module 210 that includes code to, in response to detecting even-even or odd-odd connections, fill the even-even or odd-odd connections using a reshape operation. The graph filler sub-module 210 also includes code to fill the even-even or odd-odd connections using a representation of a multiplication by an identity matrix. The tile tensor graph matrix multiplication planner module 200 includes an initializer sub-module 212 that includes code to initial outputs on a same layer type with a random packing data structure shape from a group of compatible shapes. For example, randomly selected packing data structure shapes from the same randomly selected group of shapes may be used for nodes representing final outputs. In some examples, the shapes for the nodes of the final outputs may be fixed in advance based on a target output shape. The tile tensor graph matrix multiplication planner module 200 includes a breadth-first search (BFS) sub-module 214 that includes code to execute a breadth-first search backward based on a minimum number of shapes per layer. The breadth-first search (BFS) sub-module 214 can include code to stop executing the bread-first search in response to detecting an input. The breadth-first search (BFS) sub-module 214 can include code to stop executing the bread-first search in response to detecting that all nodes of a layer each are assigned with three shapes. A cost minimizer module 216 includes code to execute a fast tile tensor matrix multiplication on each of the number of graphs to calculate a final cost for each of the number of graphs, and return a graph of the number of graphs that minimizes a final cost.

It is to be understood that any number of additional software components not shown in FIG. 2 may be included within the tangible, non-transitory, computer-readable medium 201, depending on the specific application.

FIG. 3 is a process flow diagram of an example method that can execute a tile tensor graph matrix multiplication. The method 300 can be implemented with any suitable computing device, such as the computer 101 of FIG. 1. For example, the methods described below can be implemented by the processor set 110 of FIG. 1.

At block 302, a graph of operations on tensors is split into even and odd vertical layers. The graph may be associated with a flow of simple operations to perform a complex operation. For example, the graph may represent a complex computation to be performed under homomorphic encryption. As one example, the operations may include a matrix multiplication operation. In various examples, six tile tensor shapes can be split into two groups, where even vertical layers include shapes from one of the two groups and the odd vertical layers include shapes from the other of the two groups.

At block 304, even-even or odd-odd connections are filled using a reshape operation in response to detecting even-even or odd-odd connections. For example, the reshape operation may be a multiplication by a representation of a multiplication by an identity matrix.

At block 306, outputs on a same layer type are initialized with a random packing data structure shape from a same group of compatible shapes. For example, a random packing data structure shape may be selected for each of the nodes at a final layer from the same randomly selected group of compatible shapes. As one specific example, for tile tensors, a random tile tensor shape may be chosen from one of the two compatible groups of shapes: a first group including [r,c, *] [*,r,c] [c,*,r] and a second group including [r,*,c] [c,r,*] [*,c,r], where r and c are the “rows” and “columns” of the packed matrix: [r,c, *], [*, r, c], [c,*, r], [r,*,c], [c, r,*], [*, c, r].

At block 308, a breadth-first search backward is executed based on a minimum number of shapes per layer. For example, in the case of three-dimensional tile tensors, the minimum number of shapes per layer may be one and the maximum number of shapes may be three. The breadth-first search may thus be executed to find an assignment such that every node holds only one shape, which translates to storing only one encrypted matrix or tile tensor in memory instead of the maximum of three. In various examples, each previous layer may have shapes chosen from a same group of shapes that is different than the group of shapes used for the adjacent subsequent layer.

At block 310, the breadth-first search is stopped in response to detecting an input or that all nodes of a layer are assigned with a maximal number of shapes. For example, the input may be the first layer of nodes. In the example of tile tensors, because the maximal number of tile tensor shapes is three, once a layer has all of its nodes assigned three tile tensor shapes, this means that all nodes in the prior layers corresponding to lower level layers will also have to hold three tile tensors in memory. In this case, BFS may not need to be executed any longer because the rest of the values are already known.

At block 312, a graph of operations on tensors is output having maximal numbers of shapes prior to the stopping points. For example, in the case of three-dimensional tile tensors, the graph of operations may be a multiplication graph having three shapes prior to the stopping points.

The process flow diagram of FIG. 3 is not intended to indicate that the operations of the method 300 are to be executed in any particular order, or that all of the operations of the method 300 are to be included in every case. Additionally, the method 300 can include any suitable number of additional operations. For example, different random assignments at block 306 may lead to different results. Therefore, in some embodiments, the method 300 may be executed several times to reduce the final latency or memory costs. For example, the instance with the lowest latency or memory cost may be selected and used. In addition, in the example of FIG. 3, the existence of a final layer is assumed. However, in various example graphs, there may be multiple levels for the final nodes.

FIG. 4 is a process flow diagram of an example method that can minimize a cost of a complex computation using fast tile tensor matrix multiplication. The method 400 can be implemented with any suitable computing device, such as the computer 101 of FIG. 1. For example, the methods described below can be implemented by the processor set 110 of FIG. 1.

At block 402, on an input of a complex computation, a processor finds many graph options. For example, a number of graphs based on a received input complex computation. For example, for a matrix m⁶, two graph options may be based on m²m⁴ and m³m³.

At block 404, for every graph, the processor runs tile tensor graph matrix multiplications to find a final cost. For example, the method 300 of FIG. 3 may be run for each of the graph options detected from block 402, to determine a most efficient shape assignment for each of the graph options. In various examples, any number of tile tensor graph matrix multiplications may be executed on each of the number of graphs to calculate a final cost for each of the number of graphs. The final cost may be calculated based on computation resources, memory resources, or a combination thereof. In some examples, the final cost may involve minimizing cleanup costs, or costs associated with duplication of values that may be associated with additional processing costs.

At block 406, the processor returns a graph that minimizes the final cost. For example, a graph option with its most efficient shape assignment that minimizes the final cost may be returned. As one example, for matrix m⁶, the graph option based on m²m⁴ may be returned with its most efficient shape assignment if this minimizes the final cost.

The process flow diagram of FIG. 4 is not intended to indicate that the operations of the method 400 are to be executed in any particular order, or that all of the operations of the method 400 are to be included in every case. Additionally, the method 400 can include any suitable number of additional operations.

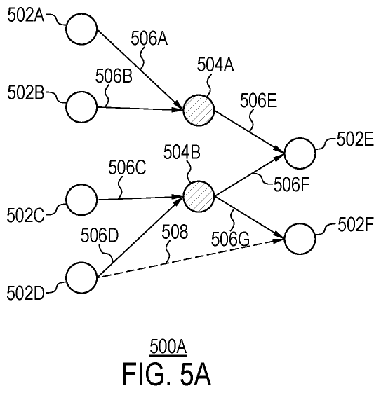

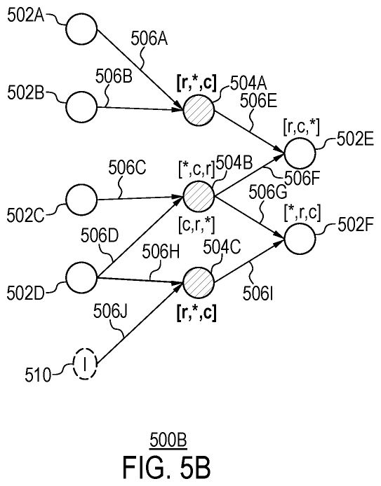

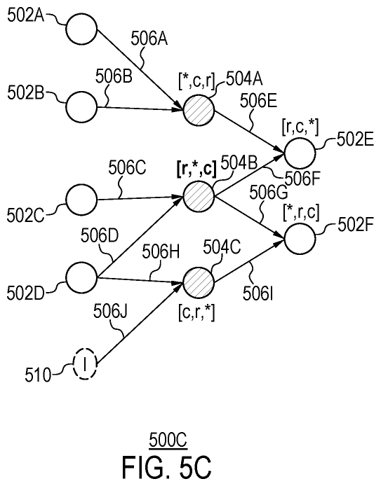

FIG. 5A is an example graph split into even and odd vertical layers with an even-even connection. The example graph 500A includes even nodes 502A, 502B, 502C, 502D in a first even layer and even nodes 502E and 502F in a second even layer. The graph 500A further includes odd nodes 504A and 504B arranged in an odd vertical layer. Even nodes 502A and 502B are connected to odd node 504A, as indicated by arrows 506A and 506B. Even nodes 502C and 502D are connected to odd node 504B, as indicated by arrows 506C and 506D. Odd nodes 504A and 504B are further connected to even node 502E, as indicated by arrows 506E and 506F. Odd node 504B is further also connected to even node 502F as indicated by an arrow 506G. Even nodes 502D and 502F are also connected, as indicated by an arrow 508.

As shown in FIG. 5A, and even-even connection 508 in the graph 500A indicates a potential issue for matrix multiplication. In particular, the combination of shapes may not be suitable for matrix multiplication. Thus, the even-even connection 508 may be replaced with a node connected to a representation of a multiplication by an identity matrix, as described in FIG. 5B.

It is to be understood that the block diagram of FIG. 5A is not intended to indicate that the graph 500A is to include all of the components shown in FIG. 5A. Rather, the graph 500A can include fewer or additional components not illustrated in FIG. 5A (e.g., additional nodes, layers, or additional connections, including odd-odd, or even-even connections, etc.). Moreover, the numbering or labeling of the alternating layers may be different in various examples. For example, the vertical layers may alternatively begin with an odd layer that follows with an even layer, etc.

FIG. 5B is an example graph split into even and odd vertical layers with a representation of a multiplication by an identity matrix used to replace the even-even connection. The example graph 500B includes similarly referenced element of FIG. 5A. In addition, the graph 500B includes a third node 504C connected to a representation 510, which has replaced the even-even connection of FIG. 5A.

In graph 500B, the representation 510 can be multiplied by the matrix represented by node 502D to produce node 504C. In this manner, the addition of an additional reshape operation resolves the even-even connection problem discussed in FIG. 5A. In various examples, any other suitable reshape operation may alternatively or additionally be used. For example, a rotate-and-mask method may alternatively or additionally be used. In the rotate-and-mask method, every element is moved to its position by rotation, then only elements in the right locations are selected using maskings.

As discussed above, there are six possible ways to pack a matrix using a 3D tile tensor, where r and c are the “rows” and “columns” of the packed matrix: [r,c, *], [*, r, c], [c,*, r], [r,*,c], [c, r,*], [*, c, r], The six shapes may be split into two groups: a first group including [r,c, *] [*,r,c] [c,*,r] and a second group including [r,*,c] [c,r,*] [*, c,r]. In the example of FIG. 5B, two shapes from the first group are selected for outputs at the final even layer. In particular, the shapes [r,c, *] and [*, r, c] are selected for use from the first group. For example, the shapes [r,c,*] and [*, r, c] may have been randomly selected from the same randomly selected group. Given randomly selected shapes [r,c,*] and [*, r, c] at the final layer, then shapes may be selected from the other group of shapes for each previous layer in a form of back propagation. For example, a breadth-first search (BFS) may be executed backwards, based on the minimum number of shapes needed per layer. In particular, the shapes of each of the previous layers may be selected to result in the output layer shapes when multiplied. For example, the shape [r,*,c] was selected for 504A and the shape [*,c,r] for node 504B based on the randomly selected shape [r,c,*] for node 502E. Notably, the multiplication of shape [r,*,c] by shape [*,c,r] results in the shape [r,c,*] for node 502E. Similarly, the shapes [c,r,*] and [r,*,c] are selected for nodes 504B and 504C, respectively, based on the randomly selected shape [*, r,c] for node 502F. The middle node 504B thus requires storing a data structure for the corresponding matrix in two different shapes [*,c,r] and [c,r,*] in order to be able to satisfy the condition of the output nodes 502E and 502F. By contrast, the nodes 504A and 504C have the same shape [r,*,c]. Thus, the initial assignment of shapes for the nodes in the graph 500B may be inefficient due to the specific selection of BFS.

It is to be understood that the block diagram of FIG. 5B is not intended to indicate that the graph 500B is to include all of the components shown in FIG. 5B. Rather, the graph 500B can include fewer or additional components not illustrated in FIG. 5B (e.g., additional nodes, layers, connections, representations, or additional types of reshape operations, etc.).

FIG. 5C is an example graph with re-ordered shapes assigned to the odd layer. The example graph 500C includes similarly referenced element of FIGS. 5A and 5B. However, the shapes associated with teach of the nodes 504A, 504B, and 504C of the odd layer have been modified such that the new shapes are [*, c,r], [r,*,c], and [c,r,*], respectively.

In various embodiments, to achieve a solution that is close to a minimal solution per layer, after the first assignment of nodes, a path may be constructed to search near nodes that share the same shape and switch the order of the nodes to see if the results are better. For example, after the initial assignment of nodes as in FIG. 5B, the order of the shapes at nodes 504A, 504B, and 504C has been changed to [*,c,r], [r,*, c], and [c,r,*]. Thus, only one shape is now stored for the matrix of node 504B, saving both computational and memory resources. In various examples, additional layers of the graph may be similarly processed. For example, because all nodes of the layer have one shape, which is less than the maximal number of three shapes for tile tensors, the processor can continue processing layers in the same way to the first layer corresponding to an input. For example, the input layer of FIG. 5C may be nodes 502A-502D and 510.

It is to be understood that the block diagram of FIG. 5C is not intended to indicate that the graph 500C is to include all of the components shown in FIG. 5C. Rather, the graph 500C can include fewer or additional components not illustrated in FIG. 5C (e.g., additional nodes, layers, connections, or additional types of reshape operations, or re-ordering of shapes, etc.). For example, although FIGS. 5A-5C depict a simple graph where all output nodes are on the same level (either even or odd), in practice, the output nodes may be on different levels, and the shapes to each node chosen according to its classification (even or odd). For example, using a textual representation:
E→C
A→B→C
D→B
A→F
   where A,D (level 1) and E (level 2) are the inputs, B (level 2) is an intermediate node, and C (level 3), F (level 2) are the outputs but on different levels 2,3. Here, shapes for C may be chosen from one group and chosen for F from a different group. The BFS may start from C and only once level 2 is reached, is F also considered.

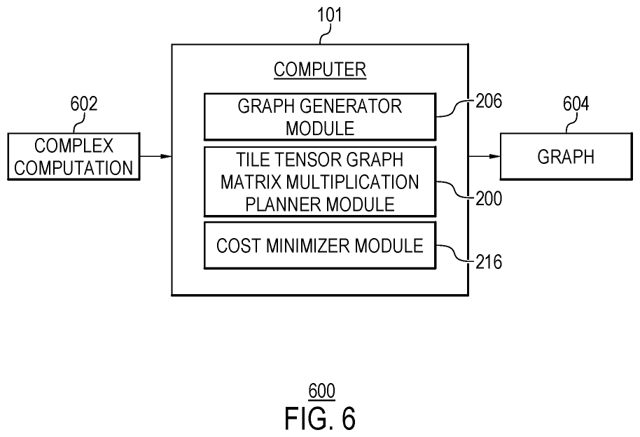

With reference now to FIG. 6, a block diagram shows an example system for performing complex computations using fast tile tensor matrix multiplication. The example system 600 of FIG. 6 includes similarly referenced element of FIGS. 1 and 2. For example, the system 600 includes a computer 101, including a graph generator module 206, a tile tensor graph matrix multiplication planner module 200, and a cost minimizer module 216. The system 600 includes a complex computation 602 shown being received at the computer 100. The system 600 also includes a graph 604 shown being output by the computer 101.

The graph generator module 206 can generate a number of graphs based on the received complex computation 602. For example, different combinations of operations such matrix multiplications may be included in the number of graphs.

As previously described, there are six possible ways to pack a matrix using a 3D tile tensor, where r and c are the “rows” and “columns” of the packed matrix: [r,c, *], [*, r, c], [c,*, r], [r,*,c], [c, r,*], [*, c, r]. In the example of FIG. 6, the graph generator module 206 can split the six shapes into two groups: a first group including [r,c,*] [*,r,c] [c,*,r] and a second group including [r,*,c] [c,r,*] [*, c,r]. Every matrix multiplication involves two matrices from the same group. In various examples, for each of the graphs generated by the graph generator module 206, the tile tensor graph matrix multiplication planner module 200 can split the graph into vertical lines of even and odd layers. For example, even layers may accommodate tile tensors of shape in a same group of compatible shapes and odd layers have tile tensors of shape from a different group of compatible shapes. In response to detecting even-even or odd-odd connections, the tile tensor graph matrix multiplication planner module 200 can fill the even-even or odd-odd connections using multiplication. Still referring to FIG. 6, the tile tensor graph matrix multiplication planner module 200 can initial outputs on a same layer type with a random packing data structure shape from the same group of compatible shapes and execute a breadth-first search backward based on a minimum number of shapes per layer. In various examples, the tile tensor graph matrix multiplication planner module 200 can stop the bread-first search in response to detecting an input or that all nodes of a layer are assigned with three shapes.

It is to be understood that the block diagram of FIG. 6 is not intended to indicate that the system 600 is to include all of the components shown in FIG. 6. Rather, the system 600 can include fewer or additional components not illustrated in FIG. 6 (e.g., additional computers, or additional computations, output graphs, etc.). For example, using alternative matrix multiplication algorithms, there may be other potential different groups of shapes that could be used. In some examples, higher dimensions of more than three dimensions may be used, and thus more than six shapes split into more than two groups.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
split a graph of operations on tensors into even and odd vertical layers;
in response to detecting even-even or odd-odd connections, fill the even-even or odd-odd connections using a reshape operation;
initialize outputs on a same layer type with a random packing data structure shape from a group of compatible shapes; and
execute a breadth-first search backward based on a minimum number of shapes per layer.

2. The system of claim 1, wherein the processor is to output a graph of operations having maximal numbers of shapes prior to stopping points.

3. The system of claim 1, wherein the processor is to stop executing the bread-first search in response to detecting that all nodes of a layer are assigned with three shapes.

4. The system of claim 1, wherein the graph is associated with a flow of simple operations to perform a complex operation.

5. The system of claim 4, wherein the processor is to generate a plurality of graphs based on a received input complex computation, execute a fast tile tensor matrix multiplication on each of the plurality of graphs to calculate a final cost for each of the plurality of graphs, and return a graph of the plurality of graphs that minimizes a final cost.

6. The system of claim 1, wherein the processor is to split six matrix shapes into two groups comprising the first group, wherein the even vertical layers comprise shapes from one of the two groups and the odd vertical layers comprise shapes from the other of the two groups.

7. The system of claim 1, wherein the reshape operation comprises a multiplication by an identity element.

8. A computer-implemented method, comprising:
splitting, via a processor, a graph of operations on tensors into even and odd vertical layers;
in response to detecting even-even or odd-odd connections, filling, via the processor, the even-even or odd-odd connections using a reshape operation;
initializing, via the processor, outputs on a same layer type with a random packing data structure shape from a group of compatible shapes; and
executing, via the processor, a breadth-first search backward based on a minimum number of shapes per layer.

9. The computer-implemented method of claim 8, wherein executing the breadth-first search comprises stopping in response to detecting an input.

10. The computer-implemented method of claim 8, wherein executing the breadth-first search comprises stopping in response to detecting that all nodes of a layer are assigned with three shapes.

11. The computer-implemented method of claim 8, comprising generating, via the processor, a plurality of graphs based on a received input complex computation.

12. The computer-implemented method of claim 11, comprising executing, via the processor, a fast tile tensor matrix multiplication on each of the plurality of graphs to calculate a final cost for each of the plurality of graphs, and returning, via the processor, a graph of the plurality of graphs that minimizes a final cost.

13. The computer-implemented method of claim 8, wherein splitting the graph comprises splitting six matrix shapes into two groups comprising the first group, wherein the even vertical layers comprise shapes from one of the two groups and the odd vertical layers comprise shapes from the other of the two groups.

14. The computer-implemented method of claim 8, wherein filling the even-even or odd-odd connections comprises using a representation of a multiplication by an identity matrix.

15. A computer program product for executing complex computations, the computer program product comprising a computer-readable storage medium having program code embodied therewith, the program code executable by a processor to cause the processor to:
split a graph of operations on tensors into even and odd vertical layers;
in response to detecting even-even or odd-odd connections, fill the even-even or odd-odd connections using a reshape operation;
initialize outputs on a same layer type with a random packing data structure shape from a group of compatible shapes; and
execute a breadth-first search backward based on a minimum number of shapes per layer.

16. The computer program product of claim 15, further comprising program code executable by the processor to stop executing the bread-first search in response to detecting an input.

17. The computer program product of claim 15, further comprising program code executable by the processor to stop executing the bread-first search in response to detecting that all nodes of a layer are assigned with three shapes.

18. The computer program product of claim 15, further comprising program code executable by the processor to generate a plurality of graphs based on a received input complex computation.

19. The computer program product of claim 15, further comprising program code executable by the processor to execute a fast tile tensor matrix multiplication on each of the plurality of graphs to calculate a final cost for each of the plurality of graphs, and return a graph of the plurality of graphs that minimizes a final cost.

20. The computer program product of claim 15, further comprising program code executable by the processor to split six matrix shapes into two groups comprising the first group, wherein the even vertical layers comprise shapes from one of the two groups and the odd vertical layers comprise shapes from the other of the two groups.
